(19) United States
(12) Patent Application Publication
(10) Pub. No.: US 2011/0238552 A1
(43) Pub. Date: Sep. 29, 2011

(54) Method And Apparatus To Facilitate Dynamic Resource Access In Wireless Networks

(76) Inventor: Pantelis Monogioudis, Randolph, NJ (US)

(21) Appl. No.: 12/732,962

(22) Filed: Mar. 26, 2010

(51) Int. Cl. G06Q 30/00; G06Q 50/00

(52) U.S. Cl. 705/37

(57) ABSTRACT

To address the need to fairly allocate resources to a number of competing and heterogeneous consumers, embodiments such as those depicted in diagram 100 may be employed. A dynamic resource access (DRA) manager receives (101) a bid for a wireless resource from each bidder of a group of bidders, each bid including a bid price. Each bidder in the group of bidders is ranked (102) based on bid price and a quality of service associated with that bidder. The wireless resource is then allocated (103) to the highest ranked bidder of the group of bidders at the bid price of the second highest ranked bidder of the group of bidders.

### FIELD OF THE INVENTION

The present invention relates generally to communication systems and, in particular, to facilitating dynamic resource access (DRA) in wireless networks.

### BACKGROUND OF THE INVENTION

The assignment of resources in response to competing requests is a well known problem in telecommunications. In mobile communications this problem has been extensively studied for the case where resource consumers (e.g., mobile terminals) request resources from a centrally managed entity (e.g., the base station). These requests contain side information such as channel quality information so that the entity can make a decision, i.e., rank the consumers according to a criterion that it tries to optimize. What is a best mechanism, though, when the nature of the problem is channel-unaware, i.e., when resources must be assigned to an consumer without the need or even the possibility to send channel quality information or when the channel quality information is not relevant? Such problems arise in wireless communications frequently.

For example, one problem is how to allocate resources to a number of competing and heterogeneous consumers. The consumers are heterogeneous in that each end-unit has a different demand function for a given resource. Here, a demand function is any convex or approximately convex function of the quantity versus price. Equivalently, each end-unit has a different valuation of the resource and this valuation is private information. New mechanisms and techniques that are able to provide a fair allocation of resources in complex situations such as this are needed to advance wireless communications.

### BRIEF DESCRIPTION OF THE DRAWINGS

FIG. 1 is a logic flow diagram of functionality performed in accordance with various embodiments of the present invention.

FIG. 2 is a logic flow diagram of functionality performed by a dynamic resource access (DRA) manager in accordance with various embodiments of the present invention.

FIG. 3 is a messaging flow diagram involving a dynamic resource access (DRA) manager and two bidders, in accordance with multiple embodiments of the present invention.

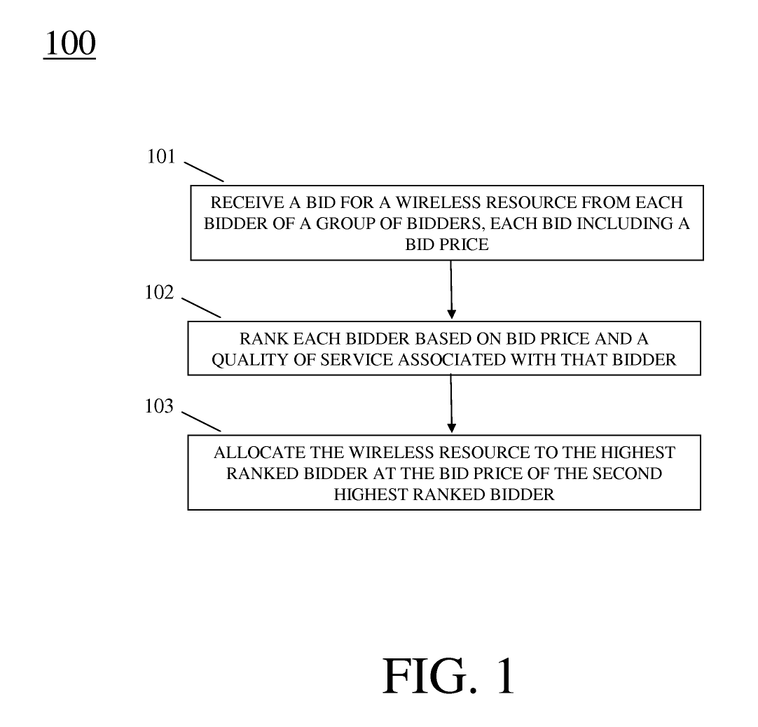

Specific embodiments of the present invention are disclosed below with reference to FIGS. 1-3. Both the description and the illustrations have been drafted with the intent to enhance understanding. For example, the dimensions of some of the figure elements may be exaggerated relative to other elements, and well-known elements that are beneficial or even necessary to a commercially successful implementation may not be depicted so that a less obstructed and a more clear presentation of embodiments may be achieved. In addition, although the logic and/or messaging flow diagrams above are described and shown with reference to specific steps performed and/or messaging communicated in a specific order, some of these steps and/or messaging may be omitted or some of these steps and/or messaging may be combined, sub-divided, or reordered without departing from the scope of the claims. Thus, unless specifically indicated, the order and grouping of steps and/or messaging is not a limitation of other embodiments that may lie within the scope of the claims.

Simplicity and clarity in both illustration and description are sought to effectively enable a person of skill in the art to make, use, and best practice the present invention in view of what is already known in the art. One of skill in the art will appreciate that various modifications and changes may be made to the specific embodiments described below without departing from the spirit and scope of the present invention. Thus, the specification and drawings are to be regarded as illustrative and exemplary rather than restrictive or all-encompassing, and all such modifications to the specific embodiments described below are intended to be included within the scope of the present invention.

### SUMMARY OF THE INVENTION

To address the need to fairly allocate resources to a number of competing and heterogeneous consumers, a method such as that depicted in diagram 100 of FIG. 1 may be employed. In one method, a dynamic resource access (DRA) manager receives (101) a bid for a wireless resource from each bidder of a group of bidders, each bid including a bid price. Each bidder in the group of bidders is ranked (102) based on bid price and a quality of service associated with that bidder. The wireless resource is then allocated (103) to the highest ranked bidder of the group of bidders at the bid price of the second highest ranked bidder of the group of bidders. An article of manufacture is also provided, the article comprising a processor-readable storage medium storing one or more software programs which when executed by one or more processors performs the steps of this method.

In another, or perhaps additional, method, a dynamic resource access (DRA) manager receives a bid for at least a portion of a group of wireless resources from each bidder of a group of bidders, each bid including a bid price. Each bidder in the group of bidders is ranked based on bid price and a quality of service associated with that bidder. At least a portion of the group of wireless resources is allocated to the highest ranked bidder of the group of bidders at the bid price of the second highest ranked bidder of the group of bidders. An article of manufacture is also provided, the article comprising a processor-readable storage medium storing one or more software programs which when executed by one or more processors performs the steps of this method.

Many embodiments are provided in which the method above is modified. In some embodiments, at least a portion of the group of wireless resources that remains unallocated is allocated to the second highest ranked bidder of the group of bidders. The second highest ranked bidder is charged the bid price of the third highest ranked bidder; however, when the group of bidders does not includes a third highest ranked bidder, the second highest ranked bidder is charged a minimum acceptable bid price. In some embodiments, the DRA manager sends an indication of the minimum acceptable bid price for at least a portion of the group of wireless resources prior to bidding.

The ranking of each bidder based on bid price and the quality of service associated with that bidder may takes various forms depending on the embodiment. For example, the ranking based on the quality of service associated with that bidder may involve ranking each bidder based on at least one aspect of a Service Level Agreement (SLA) associated with that bidder and/or based on at least one Key Performance Indicator (KPI) associated with that bidder. For example, the ranking based on the quality of service associated with that bidder may involve ranking each bidder based on at least one characteristic associated with that bidder from the group of: an average throughput per user, an average resource throughput, an average mean opinion score (MOS), a maximum average packet error rate, a maximum latency, and an UL/DL peak throughput.

An apparatus is also provided. A network manager that includes a network interface and a processing unit is described. The network interface is adapted to send and receive messaging using at least one communication protocol. The processing unit, communicatively coupled to the network interface, is adapted to receive, via the network interface, a bid for a wireless resource from each bidder of a group of bidders, each bid including a bid price, adapted to rank each bidder in the group of bidders based on bid price and a quality of service associated with that bidder, and adapted to allocate the wireless resource to the highest ranked bidder of the group of bidders at the bid price of the second highest ranked bidder of the group of bidders.

### DETAILED DESCRIPTION OF EMBODIMENTS

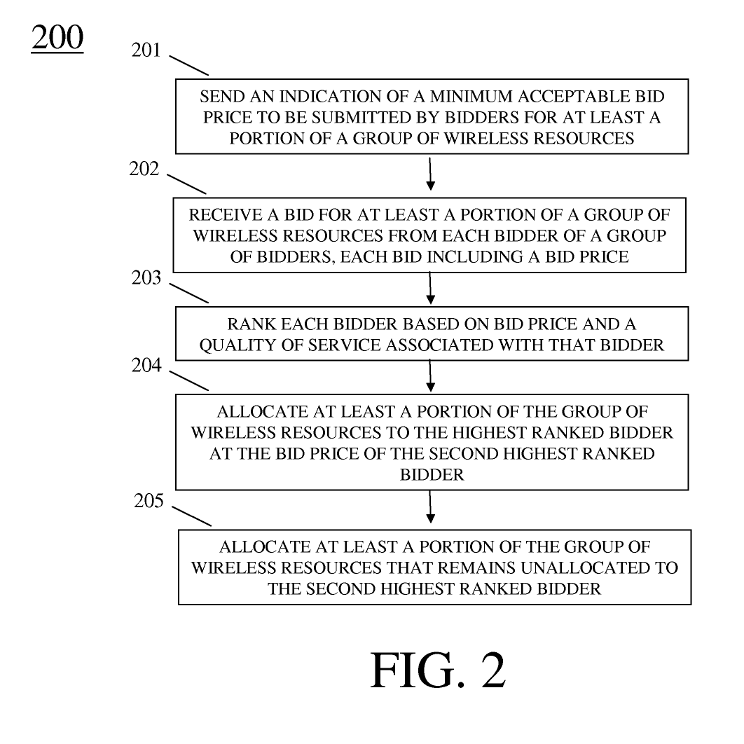

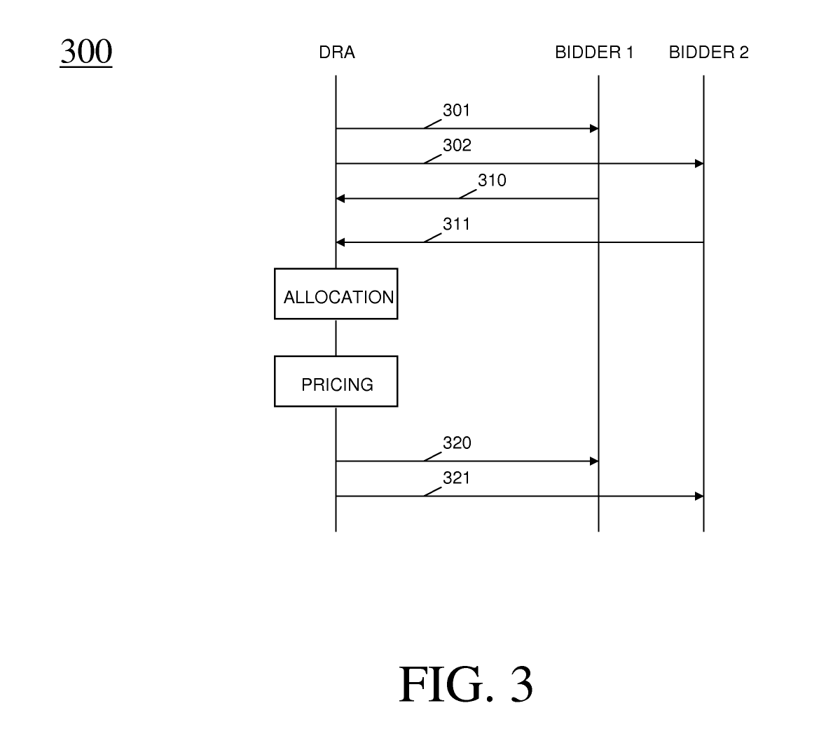

The present invention can be more fully understood with reference to FIGS. 1-3. FIGS. 1 and 2 are logic flow diagrams of functionality in accordance with multiple embodiments of the present invention. FIG. 3 is a messaging flow diagram involving a dynamic resource access (DRA) manager and two bidders, in accordance with multiple embodiments of the present invention.

To provide a greater degree of detail in making and using various aspects of the present invention, a description of our approach to dynamic resource access and a description of certain, quite specific, embodiments follows for the sake of example. FIGS. 2 and 3 are referenced in an attempt to illustrate some examples of specific embodiments of the present invention and/or how some specific embodiments may operate.

In certain embodiments, Dynamic Resource Access (DSA) is an application where a server assigns resources to consumers (e.g., operators/service providers) that are competing for particular resources. Such resources include, but are not limited to, distinct carrier frequencies, frequency sub-bands, and/or power levels. Thus, for the purpose of the discussion that follows, we assume that:
Resources are divided into chunks of resource units (RUs) and multiple resource units may constitute an allocation.
Consumers are ranked by the allocation algorithm, i.e., the highest ranked consumer is given priority in allocation of resource-units over the second highest ranked consumer.
The allocation mechanism should be fair.

The mechanism for allocation of resources for the problem in question includes a communication protocol that is based on auction theory and open market principles. Consumers are asked to bid a price normalized per resource unit and the allocation mechanism seeks to ensure that the consumer that truthfully reported its valuation for the resource and is the highest ranked bidder is allocated the resource. The communication protocol should converge to a resource allocation that maximizes the revenue of the central-unit.

In certain embodiments, the mechanism includes two functions: an allocation function and a pricing function. The allocation function receives bids from the consumers and determines the allocation of the resources. This can be thought of as solving a bipartite matching problem where buyers and sellers must be matched to clear the market or alternatively a Knapsack problem. The pricing function, determines the charge of each allocation to the consumer (the amount of money, whether actual or virtual (e.g., charge tokens, etc.) the consumer will pay/owe). Both allocation and pricing functions are centralized.

This closed loop mechanism is very challenging to study analytically and prove allocation optimality, i.e., the maximization of revenue for the resource manager. A specific pricing function that uses the second highest bid (Vickrey's work on the second-price auction mechanism resulted in the in Nobel price in Economics in 1996) results in an optimal and truthful mechanism in that the consumer's best interest is to bid truthfully, i.e., to bid the true valuation of the resource and not attempt to game the system.

The rationale around the optimal and truthful bidding is as follows. Bidders try to maximize their own utility, therefore, the amount the winner pays is not affected by his bid but by the second-highest bid. Suppose she bids her true (secret) valuation vⱼ. We can distinguish two cases:
She wins: the surplus of the bidder is vⱼ−b₂≧0. If she bets vⱼ+δ, nothing changes—she still is the winner and pays b₂. So she cannot do better by increasing her bid. If she bets vⱼ−δ and the delta is such (small enough) that she remains the winner, again nothing changes. If, though, the delta is large such that she is no longer the highest bidder, her surplus will be zero. Since the surplus was positive beforehand, she cannot do better by biding lower than vⱼ.
She loses: the surplus in this case is zero since b₁>vⱼ. If she bets vⱼ−δ, nothing changes—she still is the loser and pays 0. So she cannot do better by decreasing her bid. If she bets vⱼ+δ and the delta is such (small enough) that she remains the loser, again nothing changes. If though the delta is large such that she becomes the highest bidder, her surplus will be vⱼ−b₁≧0 since she now has to pay the second-highest bidder bid b1. Since the surplus was zero beforehand, she cannot do better by biding higher than vⱼ.
   Therefore, in both potential cases, the best strategy is to bid her true valuation. Notably, the strategy is optimal irrespectively of the bids of the other consumers in that nowhere in the analysis above have we made any assumption regarding competing bids.

One mechanism/protocol embodiment that we propose is the following with reference to diagram 300 in FIG. 3:

Step 1: Consumers initially receive reservation price (p_r) from the DRA manager, i.e., the minimum possible normalized bid they need to submit to even be considered for allocation. Bidders 1 and 2 receive messaging 301-302 from the DRA that indicates this reservation price or minimum acceptable bid. The reservation price is location, frequency band and market dependent and may be estimated itself by an inference algorithm of the competitive demand parameters for the specific location/market. Intuitively, in markets that are competitive the reservation price is higher than in markets that have limited competition. The reservation price is one approach to modulate competitiveness as it is the threshold that consumers must cross to be part of the auction. Reservation prices may also be frequency band dependent as lower frequency bands are more attractive than higher frequency bands to bidders. In conclusion, the DRA manager revenue depends on p_r and the sensitivity of the competition on p_r.

Step 2: Bids are sent to the DRA manager by bidders 1 and 2 in messaging 310-311. The optimal bid of each consumer is, according to this mechanism, her true valuation. However, consumers are able to observe the results of the auction and act strategically. The algorithm they use to come up with a bid price is proprietary to each consumer and primarily will depend on the demand estimates that they have, i.e., the utilization of the resource they bid for by their wireless consumers.

Step 3: DRA decides the allocation and prices that the winner(s) must pay. In this embodiment, the ranking of consumers is decided by a quality metric that is a function of bid price and service reliability/quality of service. This is important as the DRA manager must consider not only its own revenue, but also fairness and the quality of service that is being experienced by the wireless end-users of the resources. For if DRA considered only revenue, it would select the highest bidder. Instead, this embodiment suggest a rank-based approach where each bidder rank is a function of the bid price, the Service Level Agreement (SLA) SLA agreement and/or a range of Key Performance Indicators KPIs that the DRA obtains from standardized network management interfaces. The rank-based approach allows the possibility to allocate resources to unreliable service providers that happen to bid high. The ranking function and the algorithms that estimate the quantities necessary to provide a rank for each service provider is outside the scope of this embodiment.

Use of aspects of an SLA or various KPIs enables a DRA manager to rank or prioritize the service providers either statically or dynamically. KPIs can be thought of measured QoS (quality of service) while SLA can be thought of as QoS Class. Measured QoS is a more dynamic quantity than SLA, which is a static contract between the service provider and the DRA manager. Examples of KPIs/QoS attributes include average throughput per user, average resource throughput, average mean opinion score (MOS), etc. Examples of SLA/QoS attributes include maximum average packet error rate, maximum latency, UL/DL peak throughput.

An SLA is a contractual guarantee that the QoS will be at a class or better. For example, three QoS classes may be gold, silver and bronze. The QoS measurements that are done by the DRA manager must meet the SLA over long periods of time. The DRA may include the ability to obtain direct measurement of QoS from the end-user or from probes in the service provider network.

In one embodiment, the ranking of consumers is decided by a quality metric that is a linear function of bid price (b) and quality of service (q). Y=f(b,q) where Y is a score to be used for the ranking and f(b,q)=beta_{—}1 b+beta_{—}2 q where beta_{—}1 and beta_{—}2 are weight factors that are determined by the DRA. In other embodiments the DRA may include a non-linear function to combine bid and quality of service attributes.

Step 4: DRA sends messaging 320-321 to bidders 1 and 2 indicating each bidder's allocation and charge or price. The winner pays the bid price of the next best (in rank) consumer. For example, if consumers c=(c1, c2, c3) send in bid prices b=(b1, b2, b3) respectively, and are ranked as c1>c2>c3, the highest ranked consumer c1 will be charged b2 and will occupy position 1 for priority in allocation, the second highest ranked consumer c2 will be charged b3 and will occupy position 2 and the third highest ranked consumer c3 will be charged 0 (or a minimum reservation limit that is set by the DRA to be considered in the auction) and will occupy position 3.

More generally, then, certain proposed embodiments can be summarized with reference to diagram 200 in FIG. 2. A DRA manager sends (201) an indication of a minimum acceptable bid price for at least a portion of a group of wireless resources prior to bidding. The DRA manager receives (202) a bid for at least a portion of the group of wireless resources from each bidder of a group of bidders, each bid including a bid price. Each bidder in the group of bidders is ranked (203) based on bid price and a quality of service associated with that bidder. At least a portion of the group of wireless resources is allocated (204) to the highest ranked bidder of the group of bidders at the bid price of the second highest ranked bidder of the group of bidders. In addition, at least a portion of the group of wireless resources that remains unallocated is allocated to the second highest ranked bidder of the group of bidders.

The detailed and, at times, very specific description above is provided to effectively enable a person of skill in the art to make, use, and best practice the present invention in view of what is already known in the art. In the examples, specifics are provided for the purpose of illustrating possible embodiments of the present invention and should not be interpreted as restricting or limiting the scope of the broader inventive concepts.

Benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

As used herein and in the appended claims, the term “comprises,” “comprising,” or any other variation thereof is intended to refer to a non-exclusive inclusion, such that a process, method, article of manufacture, or apparatus that comprises a list of elements does not include only those elements in the list, but may include other elements not expressly listed or inherent to such process, method, article of manufacture, or apparatus. The terms a or an, as used herein, are defined as one or more than one. The term plurality, as used herein, is defined as two or more than two. The term another, as used herein, is defined as at least a second or more. Unless otherwise indicated herein, the use of relational terms, if any, such as first and second, top and bottom, and the like are used solely to distinguish one entity or action from another entity or action without necessarily requiring or implying any actual such relationship or order between such entities or actions.

The terms including and/or having, as used herein, are defined as comprising (i.e., open language). The term coupled, as used herein, is defined as connected, although not necessarily directly, and not necessarily mechanically. Terminology derived from the word “indicating” (e.g., “indicates” and “indication”) is intended to encompass all the various techniques available for communicating or referencing the object/information being indicated. Some, but not all, examples of techniques available for communicating or referencing the object/information being indicated include the conveyance of the object/information being indicated, the conveyance of an identifier of the object/information being indicated, the conveyance of information used to generate the object/information being indicated, the conveyance of some part or portion of the object/information being indicated, the conveyance of some derivation of the object/information being indicated, and the conveyance of some symbol representing the object/information being indicated. The terms program, computer program, and computer instructions, as used herein, are defined as a sequence of instructions designed for execution on a computer system. This sequence of instructions may include, but is not limited to, a subroutine, a function, a procedure, an object method, an object implementation, an executable application, an applet, a servlet, a shared library/dynamic load library, a source code, an object code and/or an assembly code.

What is claimed is:

1. A method to facilitate dynamic resource access (DRA) in a wireless network comprising:
receiving by a dynamic resource access (DRA) manager a bid for a wireless resource from each bidder of a group of bidders, each bid including a bid price;
ranking each bidder in the group of bidders based on bid price and a quality of service associated with that bidder;
allocating the wireless resource to the highest ranked bidder of the group of bidders at the bid price of the second highest ranked bidder of the group of bidders.

2. The method as recited in claim 1, further comprising:
sending by the DRA manager an indication of a minimum acceptable bid price to be submitted by bidders for the wireless resource.

3. The method as recited in claim 1, wherein ranking each bidder based on bid price and the quality of service associated with that bidder comprises:
ranking each bidder based on at least one aspect of a Service Level Agreement (SLA) associated with that bidder.

4. The method as recited in claim 1, wherein ranking each bidder based on bid price and the quality of service associated with that bidder comprises:
ranking each bidder based on at least one Key Performance Indicator (KPI) associated with that bidder.

5. The method as recited in claim 1, wherein ranking each bidder based on bid price and the quality of service associated with that bidder comprises:
ranking each bidder based on at least one characteristic associated with that bidder from the group of:
an average throughput per user,
an average resource throughput,
an average mean opinion score (MOS),
a maximum average packet error rate,
a maximum latency, and
an UL/DL peak throughput.

6. An article of manufacture comprising a processor-readable storage medium storing one or more software programs which when executed by one or more processors performs the steps of the method of claim 1.

7. A method to facilitate dynamic resource access (DRA) in a wireless network comprising:
receiving by a dynamic resource access (DRA) manager a bid for at least a portion of a group of wireless resources from each bidder of a group of bidders, each bid including a bid price;
ranking each bidder in the group of bidders based on bid price and a quality of service associated with that bidder;
allocating at least a portion of the group of wireless resources to the highest ranked bidder of the group of bidders at the bid price of the second highest ranked bidder of the group of bidders.

8. The method as recited in claim 7, further comprising:
allocating at least a portion of the group of wireless resources that remains unallocated to the second highest ranked bidder of the group of bidders

9. The method as recited in claim 8, wherein allocating to the second highest ranked bidder comprises:
allocating to the second highest ranked bidder at the bid price of the third highest ranked bidder of the group of bidders.

10. The method as recited in claim 8, wherein allocating to the second highest ranked bidder comprises:
allocating to the second highest ranked bidder at a minimum acceptable bid price, when the group of bidders does not includes a third highest ranked bidder.

11. The method as recited in claim 7, further comprising:
sending by the DRA manager an indication of a minimum acceptable bid price to be submitted by bidders for at least a portion of the group of wireless resources.

12. The method as recited in claim 7, wherein ranking each bidder based on bid price and the quality of service associated with that bidder comprises:
ranking each bidder based on at least one aspect of a Service Level Agreement (SLA) associated with that bidder.

13. The method as recited in claim 7, wherein ranking each bidder based on bid price and the quality of service associated with that bidder comprises:
ranking each bidder based on at least one Key Performance Indicator (KPI) associated with that bidder.

14. The method as recited in claim 7, wherein ranking each bidder based on bid price and the quality of service associated with that bidder comprises:
ranking each bidder based on at least one characteristic associated with that bidder from the group of:
an average throughput per user,
an average resource throughput,
an average mean opinion score (MOS),
a maximum average packet error rate,
a maximum latency, and
an UL/DL peak throughput.

15. An article of manufacture comprising a processor-readable storage medium storing one or more software programs which when executed by one or more processors performs the steps of the method of claim 7.

16. A network manager comprising:
a network interface adapted to send and receive messaging using at least one communication protocol;
a processing unit, communicatively coupled to the network interface,
adapted to receive, via the network interface, a bid for a wireless resource from each bidder of a group of bidders, each bid including a bid price,
adapted to rank each bidder in the group of bidders based on bid price and a quality of service associated with that bidder, and
adapted to allocate the wireless resource to the highest ranked bidder of the group of bidders at the bid price of the second highest ranked bidder of the group of bidders.
